(19) United States
(12) Patent Application Publication
(10) Pub. No.: US 2016/0171457 A1
(43) Pub. Date: Jun. 16, 2016

(54) ELECTRONIC PAYMENT SYSTEM

(71) Applicant: MasterCard Asia/Pacific Pte. Ltd., Singapore (SG)

(72) Inventors: Donghao HUANG, Singapore (SG); Bensam JOYSON, Singapore (SG); Zhiwei ZHOU, Singapore (SG); Jasmine NG, Singapore (SG)

(21) Appl. No.: 14/969,323

(22) Filed: Dec. 15, 2015

(30) Foreign Application Priority Data
Dec. 15, 2014 (SG) 10201408378S

(51) Int. Cl. G06Q 20/10; G06Q 20/32

(52) U.S. Cl. CPC G06Q 20/10; G06Q 20/3223

(57) ABSTRACT

The present invention relates generally to cashless payment systems and, in particular, to an electronic payment system suitable for peer-to-peer payments. A transaction system comprising: a network connected device for receiving and communicating transaction data, the transaction data comprising data associated with payer account details, payee account details and a transaction value; and a payment server for receiving the transaction data from the network connected device, for facilitating a debit transaction to a first entity defined by the payer account details, and a credit transaction to a second entity defined by the payee account details, whereby the first entity debits a first account defined by the payer account details and the second entity credits a second account defined by the payee account details.

### CROSS-REFERENCE TO RELATED APPLICATION

This application is a U.S. National Stage filing under 35 U.S.C. §119, based on and claiming benefit of and priority to SG Patent Application No. 10201408378S filed 15 Dec., 2014.

### TECHNICAL FIELD

The present invention relates generally to cashless payment systems and, in particular, to an electronic payment system suitable for peer-to-peer payments.

### BACKGROUND

Cash, which is money in a physical form whether notes or coins, has been part of our society for many generations. There are however many instances where cash is not the most desirable means of payment. Such instances include when the payments have a low value. Often the payer does not have the correct amount of cash, or the payee does not have the correct amount of change. Also, inadvertently the payer can end up with too many coins which are inconvenient to carry around.

As a result, many attempts have been made to develop a cashless payment system. Cashless payment systems that are becoming increasingly popular include credit and debit card systems mainly due to their wide acceptance. In those systems, a cardholder makes a payment without cash. In the case of a credit card, a financial institution, termed an issuer, extends credit to the cardholder to cover purchases from participating merchants, and then later bills the cardholder for the purchase price. In the case of a debit card the payment is covered by an immediate electronic debit of a bank account.

In the credit card system, merchants are equipped by an “acquirer”, which is typically a bank, with a point-of-sale terminal. The point-of-sale terminal is linked to the computer system of the acquirer. During a transaction, the point-of-sale terminal reads card details from the card, typically from a magnetic strip or chip, and sends transaction data to the acquirer where transactions are batched. The acquirer periodically sends the batched transactions to a credit card association. The credit card association debits the issuer, which in turn invoices the cardholder. The credit card association also credits the acquirer, which pays the merchant.

However, the set-up cost to set up a payment infrastructure for small merchants is high. Also, the processing and transaction costs applied to credit and debit cards can be restrictive, especially when individual payments have a low value, typical of small merchants in marketplace environments.

Other systems proposed in the past included the use of smart cards and associated readers, allowing value to be transferred from a purchaser's smart card to a merchant's reader. The merchant is then able to, typically at a later time, connect the reader to the merchant's bank's system in order to transfer the value to the merchant's account.

Other systems, typically employed by large retail chains and the like, provide each customer with a card identifying a prepayment account. The customer is able to deposit value into the account, and upon making a purchase, tender the card in which case the customer's account is appropriately debited. However, such systems require all the point-of-sale terminals to be connected to a server managing the customer accounts. Also, the customer requires accounts with each separate system, and has to ensure the respective accounts each has the required minimum balance.

Accordingly, a need exists for an alternative cashless payment system.

### SUMMARY

According to a first aspect of the present disclosure, there is provided a transaction system comprising:
a network connected device for receiving and communicating transaction data, the transaction data comprising data associated with payer account details, payee account details and a transaction value; and
a payment server for receiving the transaction data from the network connected device, for facilitating a debit transaction to a first entity defined by the payer account details, and a credit transaction to a second entity defined by the payee account details.

According to a second aspect of the present disclosure, there is provided a payment server configured for:
receiving transaction data directly from a network connected device, the transaction data comprising data associated with payer account details, payee account details and a transaction value; and
facilitating a debit transaction to a first entity defined by the payer account details, and a credit transaction to a second entity defined by the payee account details, whereby the first entity debits a first account defined by the payer account details and the second entity credits a second account defined by the payee account details.

According to a third aspect of the present disclosure, there is provided a transaction method comprising the steps of:
receiving by a network connected device transaction data, the transaction data comprising data associated with payer account details, payee account details and a transaction value;
communicating by the network connected device the transaction data to a payment server;
facilitating by the payment server a debit transaction to a first entity defined by the payer account details, and a credit transaction to a second entity defined by the payee account details;
debiting by the first entity a first account defined by the payer account details; and
crediting by the second entity a second account defined by the payee account details.

Other aspects of the invention are also disclosed.

### BRIEF DESCRIPTION OF THE DRAWINGS

One or more embodiments of the present invention will now be described with reference to the drawing, in which:

FIG. 1 shows a schematic block diagram of the payment system according to the present disclosure.

### DESCRIPTION OF EMBODIMENTS

Disclosed herein is a payment system enabling transactions between two parties, herein after referred to as the payer and the payee. The payer and payee may be a customer and a merchant respectively. However, the disclosed payment system is also applicable to peer-to-peer (P2P) payments such as paying a babysitter or paying a roommate for a share of common expenses.

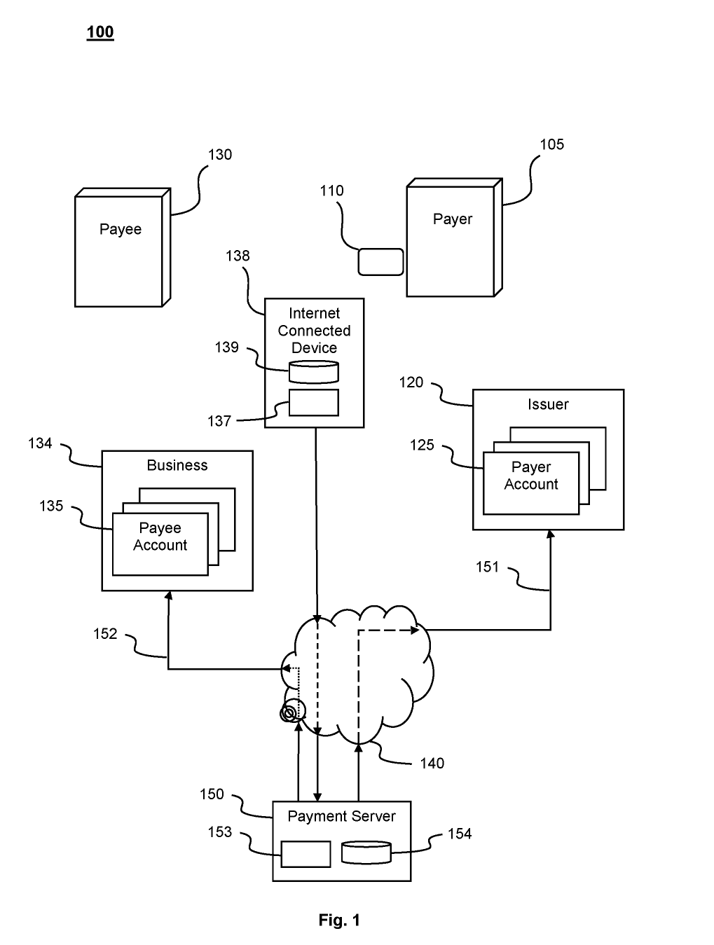

FIG. 1 shows a schematic block diagram of the payment system 100 according to the present disclosure. FIG. 1 also shows the flow of information between entities in the system 100. The payer 105 is provided with a card 110 issued by an issuer 120. The issuer 120 manages an account 125 belonging to the payer 105 and associated with the card 110. The account 125 is termed “payer account” hereafter.

The card 110 is typically a credit card sized card with the customer's details embossed thereon. However, a physical card 110 is not required. The sole purpose of the card 110 is to provide a unique identifier for identifying the payer account 125. Accordingly, an identifier uniquely identifying the payer 105 and the issuer 120 would serve the same purpose.

The payer account 125 is a debit account, meaning the balance of funds in the account has to be positive. The payer 105 is required to transfer funds to the customer account 125 to maintain a minimum balance. It is noted that the issuer 120 may be any participating business, including banks and retail chains.

The payee 130 also has an account 135, termed “payee account” hereafter. In the event that the payee is a merchant, the payee account 135 is typically held by a bank. However, in the case that the payee 130 is an individual, the payee account 130 may similarly be with any participating business 134.

In order for the payer 105 to make a payment to the payee 130, the payer 105 presents the card 110 as payment to the payee 130. The payee 130 uses a network connected device 138 executing appropriate software, to submit transaction data directly to a payment server 150 via a communications network 140. The term “directly” as used herein means data is communicated from the network connected device 138 to the payment server 150 without passing through any financial institution. The transaction data include details of the payee account 135, payer account 120, and a transaction value. The communications network 140 is typically a public wide area network, such as the Internet and can include wired and/or wireless interconnections.

The network connected device 138 is preferably a mobile computing device, such as a smartphone or tablet computer. The device 138 includes a processor 137, a storage device 139, and user interface modules (not illustrated). The processor 137 executes an application (or colloquially an app which is a self-contained software program designed to fulfil a particular purpose) stored on the storage device 139. In one implementation the Internet connected device 138 is associated with the payee 130. In this implementation the details of the payee account 135 is stored locally on the device 138, and those details are thus pre-populated in the application. The payer account 120 details and the transaction value are thus entered and communicated by the device 138 to the payment server 150 in the manner known in the art.

The network connected device 138 may equally be associated with the payer 105. In that implementation it is the payer account 125 details that are stored locally on the device 138, with those details being pre-populated. In yet another implementation the device 138 is not associated with either of the payer 105 or the payee 130.

The payment server 150 includes one or more processors 153 and storage devices 154. The processor 153 is programmed to, upon receipt of the transaction data from the network connected device 138, creates two transactions. Firstly, a debit transaction 151 is created which is sent to the issuer 120. The second transaction created by the payment server 150 is a credit transaction 152 which is sent to the business 134 managing the payee account 135. The creation of the debit and credit transactions 115 and 152 is termed “transaction splitting”.

The issuer 120 uses the information contained in the debit transaction 151 to debit the customer account 125. The business 134 managing the payee account 135 uses the information contained in the credit transaction 152 to credit the merchant account 135. The result is that the transaction value is transferred from the customer account 125 to the merchant account 135.

Optionally a transaction receipt is delivered asynchronously via email or SMS to a computing device, such as a smartphone or tablet computer of the payer 105 and/or payee 130. Typically the transaction receipt originate from the transaction server, with the transaction data received from device 138 including the email address and/or telephone number(s) to which the transaction receipt is to be sent.

Alternatively, the business 134 managing the payee account 135 may hold the contact details of the payee 130 and automatically send a payment receipt acknowledgement to the payee. However, as the credit transaction 152 preferably does not contain any details regarding the payer 105, the payment receipt acknowledgement would not include payer information.

Importantly, the system 100 described above does not require either the payer 105 or the payee 130 to maintain an account with the payment server 150. The payment server merely performs payment splitting based upon the transaction data received from the Internet connected device 138.

It would be understood that one or more of the issuer 120, business 134 and the payment server 150 may apply transaction charges to the transactions, in which case the transaction value is adjusted accordingly. Such transaction charges may be on a sliding scale and/or capped.

The transaction values and values stored in the accounts 125 and 135 do not have to correspond to the currency of the relevant country. In the preferred implementation the values are rounded off at 4 decimal points instead of the usual 2 decimal points used in most currencies, further enabling low-value transactions.

A major advantage of the disclosed system 100 is that it provides an open platform for customers. For example, a customer, being the payer 105, may have a prepayment account with a coffee chain, acting as the issuer 120. The payee 130 in this example may be a merchant selling magazines. Through the use of the disclosed system 100 the customer is able to pay for the magazine using its coffee chain card, in which case the customer's payer account 125 with the coffee chain is debited, and the merchant's account 135 is credited with the appropriate value.

Similarly, a first person, acting as payer 105, having an account with a burger chain, acting as issuer 120, may transfer value to another person, acting as payee 130, having an account with a dry-cleaning chain, acting as business 134.

Due to the open platform nature of the disclosed payment system, the payer and payee accounts 125 and 135 may be with a business, a bank, or even other “solution providers”, such as, by way of example only, M-Pesa. Accordingly, the disclosed payment system enables the payer having an M-Pesa account to transfer funds to the payee from the M-Pesa account.

The foregoing describes only some embodiments of the present invention, and modifications and/or changes can be made thereto without departing from the scope and spirit of the invention, the embodiments being illustrative and not restrictive.

1. A transaction system comprising:
a network connected device for receiving and communicating transaction data, the transaction data comprising data associated with payer account details, payee account details and a transaction value; and
a payment server for receiving the transaction data from the network connected device, for facilitating a debit transaction to a first entity defined by the payer account details, and a credit transaction to a second entity defined by the payee account details, whereby the first entity debits a first account defined by the payer account details and the second entity credits a second account defined by the payee account details.

2. A transaction system according to claim 1 wherein the network connected device is a mobile computing device executing an application for receiving the transaction data.

3. A transaction system according to claim 1 wherein the transaction value is rounded off to a fraction of a currency in which the transaction value is represented.

4. A transaction system according to claim 1 wherein the first entity is a non-financial institution business.

5. A transaction system according to claim 1 wherein the first account is a debit account.

6. A payment server configured for:
receiving transaction data directly from a network connected device, the transaction data comprising data associated with payer account details, payee account details and a transaction value; and
facilitating a debit transaction to a first entity defined by the payer account details, and a credit transaction to a second entity defined by the payee account details, whereby the first entity debits a first account defined by the payer account details and the second entity credits a second account defined by the payee account details.

7. A payment server according to claim 6 wherein the first entity is a non-financial institution business.

8. A transaction method comprising the steps of:
receiving by a network connected device transaction data, the transaction data comprising data associated with payer account details, payee account details and a transaction value;
communicating by the network connected device the transaction data to a payment server;
facilitating by the payment server a debit transaction to a first entity defined by the payer account details, and a credit transaction to a second entity defined by the payee account details;
debiting by the first entity a first account defined by the payer account details; and
crediting by the second entity a second account defined by the payee account details.

9. A transaction method according to claim 8 wherein the transaction value is rounded off to a fraction of a currency in which the transaction value is represented.
